(19) United States
(12) Patent Application Publication
(10) Pub. No.: US 2026/0227596 A1
(43) Pub. Date: Aug. 6, 2026

(54) PORTABLE AERIAL IMAGE DISPLAY DEVICE

(71) Applicant: INTERMAN CORPORATION, Kagoshima-shi, Kagoshima (JP)

(72) Inventors: Yoshimasa SAITOH, Tokyo (JP); Shigeki UETABIRA, Kagoshima-shi (JP)

(73) Assignee: INTERMAN CORPORATION, Kagoshima-shi, Kagoshima (JP)

(21) Appl. No.: 19/147,399

(22) PCT Filed: Dec. 27, 2023
(86) PCT No.: PCT/JP2023/047016

§ 371 Date: Jul. 11, 2025

(30) Foreign Application Priority Data
Jan. 29, 2023 (JP) 2023-011443

(51) Int. Cl. G02B 7/22; G02B 30/56

(52) U.S. Cl. CPC G02B 7/22; G02B 30/56

(57) ABSTRACT

A portable aerial image display device includes a housing, an optical plate pivotally supported by the housing, and a display device mounted on the housing. The optical plate can pivot from a portable position parallel to the display device to an operating position held at a predetermined angle with respect to the display device, and when the optical plate is in the operating position, the image displayed on the display device is formed as an aerial image on the opposite side of the optical plate. A light-shielding member surrounding the space between the optical plate and the housing is provided, and the light-shielding member expands and contracts in accordance with changes in the gap between the housing and the optical plate as the space expands and contracts due to the rotation of the optical plate relative to the housing.

### FIELD

The present invention relates to a small, portable aerial image display device capable of displaying aerial images.

### BACKGROUND

In recent years, there has been growing interest in aerial image display devices. The pandemic caused by the novel coronavirus has made people realize how vulnerable 21st-century society, with its high population density and era of high-speed mass transportation, is to infectious diseases. In such circumstances, everything around us may seem like a source of infection, making daily life extremely restrictive. In fact, during the spread of infection, it is necessary to treat everything with suspicion.

While it is important to take measures such as wearing masks, maintaining sufficient distance from others, and avoiding crowds, it is unavoidable to have minimal contact with infection routes in order to maintain necessary social life. Minimizing this risk is essential to prevent infection.

For example, at bank ATMs, supermarket self-checkout counters, corporate reception desks, and hotel check-ins, an unspecified number of users operate the same touch panel. Such touch panels can potentially become routes of infection. To avoid this risk, it is necessary to disinfect the touch panel each time the user changes, but such measures are quite laborious and difficult to perform adequately.

In recent years, in such circumstances, technology that allows non-contact operation of aerial images formed in the air using special optical elements has attracted attention. By using this technology, it is possible to realize a completely non-contact interface with usability similar to conventional touch panels.

For example, Patent Document 1 discloses a system in which, a contactless remote pointer control device with an aerial imaging technology is used to operate a mouse displayed on the device. This is because it is considered unhygienic for a surgeon to touch pointing devices such as a computer mouse during surgery. As such special optical elements, for example, the optical imaging device described in Patent Document 2 can be used.

### PATENT DOCUMENTS

[Patent Document 1] Japanese Patent Published Application No. 2018-147054
[Patent Document 2] International Publication No. 2009/131128

### SUMMARY

The sight of an image floating in empty space by aerial imaging technology alone is impactful and helps create a futuristic atmosphere. Furthermore, when displayed as an aerial image, it feels three-dimensional as it appears to float from its surroundings. For these reasons, many applications other than infection prevention measures can be considered. For example, applying it to digital signage can attract more attention. Use in entertainment such as games has also been proposed.

As the places of use diversify in this way, there is a demand to move the device to various locations for use. However, current aerial image display devices are mainly stationary types, that is, they are basically installed at a fixed location and not moved afterwards. In this case, for example, it is not possible to put it in a bag and perform contactless online payments at a destination.

Therefore, the object of the present invention is to provide a portable aerial image display device that can be folded compactly and carried freely.

To solve the above problems, one aspect of the portable aerial image display device according to the present invention comprises a support; an optical plate pivotally supported by the support; and a display device mounted on the support, wherein the optical plate can pivot between a portable position substantially parallel to the support and an operating position held at a predetermined angle with respect to the support, wherein, when the optical plate is in the operating position, the image displayed on the display device is formed as an aerial image on the opposite side of the optical plate, wherein a light-shielding member surrounding the space between the optical plate and the support is provided, and wherein the light-shielding member expands and contracts in accordance with changes in the gap between the support and the optical plate as the space expands and contracts due to the rotation of the optical plate relative to the support.

In one embodiment, the light-shielding member comprises a plurality of light-shielding plates, each pivotally supported by the support together with the optical plate, and these light-shielding plates overlap each other in a slidable manner in the pivoting direction of the optical plate, substantially surrounding the space between the optical plate and the support without gaps.

In another embodiment, the support can also hold the optical plate at an intermediate position between the operating position and the portable position, and at this intermediate position, the image displayed on the display device is formed as an aerial image on the opposite side of the optical plate.

In a further embodiment, the pivotal support structure between the support and the optical plate is provided with a free-stop function that holds the optical plate at any angle relative to the support.

In a further embodiment, the free-stop function is implemented by a torque hinge.

According to the portable aerial image display device of the present invention, it is possible to achieve a clear aerial image by eliminating the influence of external light, and at the same time, it can be folded compactly and carried freely.

### BRIEF DESCRIPTION OF THE DRAWINGS

FIG. 1 is a perspective view showing the aerial image display device 1 in use according to an embodiment of the present invention.

FIG. 2 is a sectional view along line A-A of FIGS. 1 and 3 showing the aerial image display device 1 in use according to the embodiment of the present invention.

FIG. 3 is a sectional view along line B-B of FIGS. 1 and 2 showing the aerial image display device 1 in use according to the embodiment of the present invention.

FIG. 4 is a sectional view along line C-C of FIGS. 1 and 2 showing the aerial image display device 1 in use according to the embodiment of the present invention.

FIG. 5 is a perspective view showing the folded state of the aerial image display device 1 shown in FIGS. 1 to 4.

FIG. 6 is a side view showing another usage mode of the aerial image display device 1 according to the embodiment of the present invention.

FIG. 7 is a view showing another example of implementing the free-stop function to hold the lid member 22 of the aerial image display device 1 at any angle.

### DETAILED DESCRIPTION

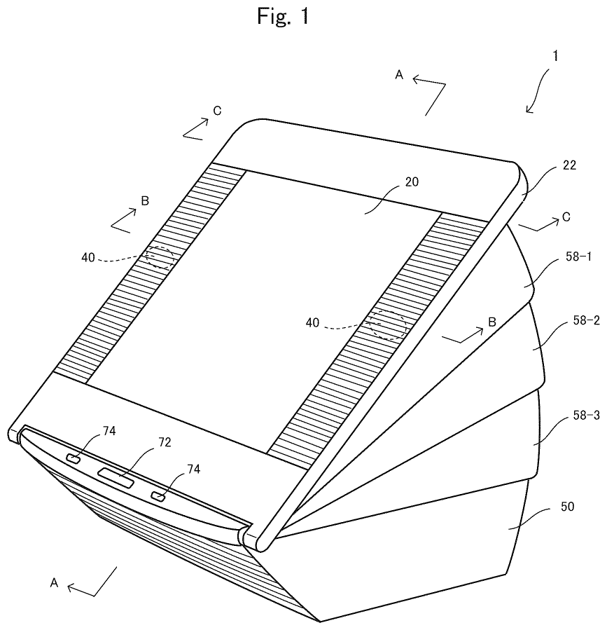

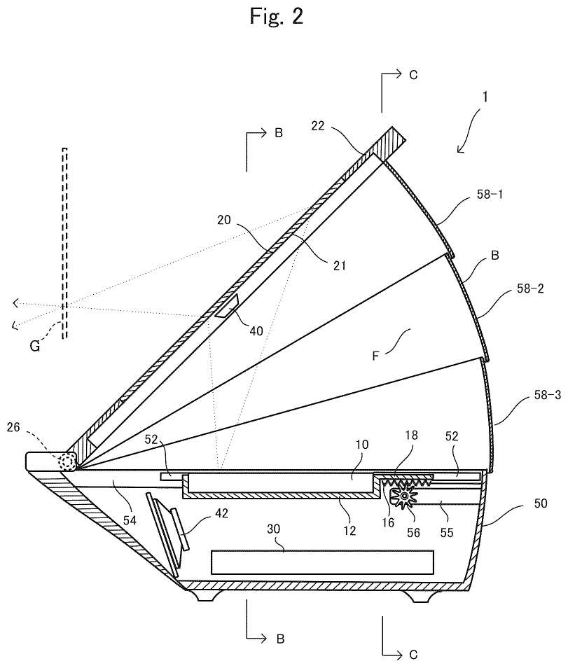

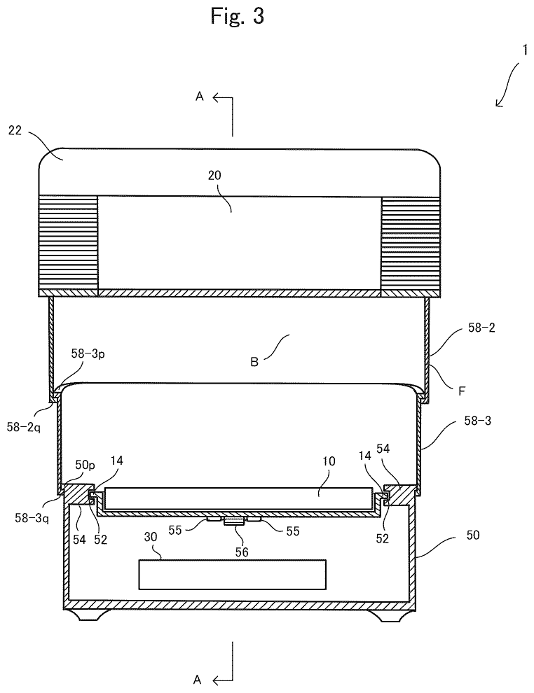

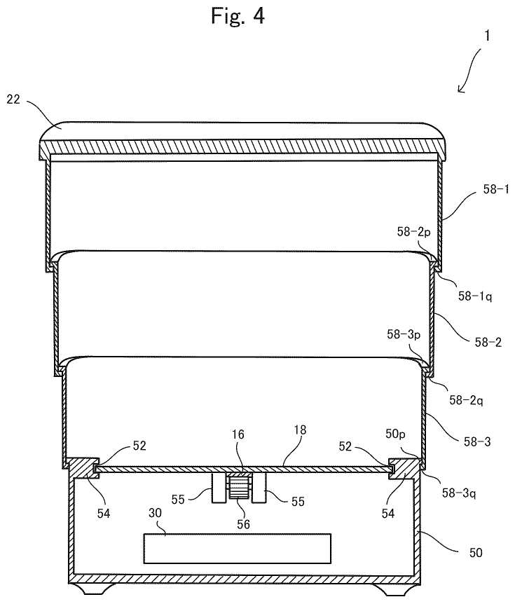

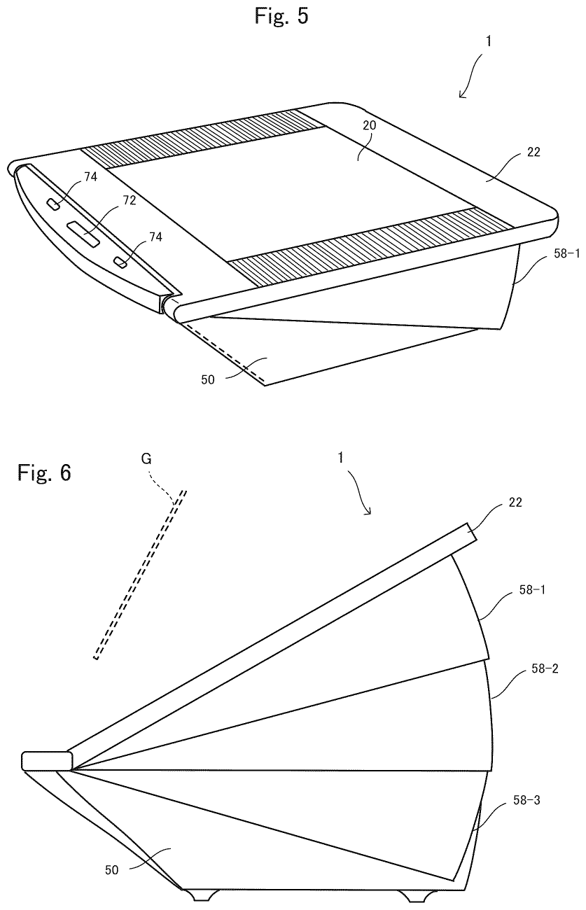

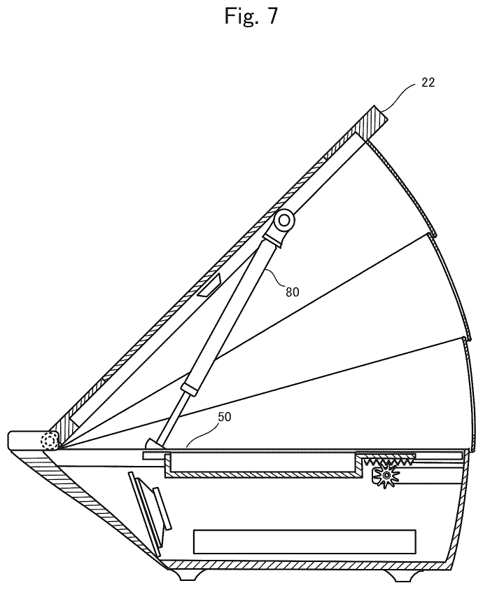

Hereinafter, an embodiment of the portable aerial image display device according to the present invention will be described with reference to the attached drawings. FIG. 1 is a perspective view showing the aerial image display device 1 in use according to an embodiment of the present invention. FIG. 2 is a sectional view along line A-A of FIGS. 1 and 3 showing the aerial image display device 1 in use according to the embodiment of the present invention. FIG. 3 is a sectional view along line B-B of FIGS. 1 and 2 showing the aerial image display device 1 in use according to the embodiment of the present invention. FIG. 4 is a sectional view along line C-C of FIGS. 1 and 2 showing the aerial image display device 1 in use according to the embodiment of the present invention. FIG. 5 is a perspective view showing the folded state of the aerial image display device 1 shown in FIGS. 1 to 4. FIG. 6 is a side view showing another usage mode of the aerial image display device 1 according to the embodiment of the present invention.

As shown in FIGS. 1 to 3, the aerial image display device 1 includes a liquid crystal display 10 and an optical plate 20 as essential components. In addition, the aerial image display device 1 is also equipped with an information processing device 30 that controls the liquid crystal display 10, as well as a speaker 40 and a woofer 42. Here, the liquid crystal display 10, the speaker 40, and the woofer 42 are housed inside a housing 50 and are each connected to the information processing device 30 by signal lines (not shown in the drawings).

The information processing device 30 is essentially a small computer composed of a CPU (Central Processing Unit), a ROM (Read Only Memory), a RAM (Random Access Memory), a storage device storing various programs and data, and input/output interfaces. The input/output interfaces may include, for example, USB ports and wireless LAN such as Wi-Fi. The information processing device 30 outputs video signals to the liquid crystal display 10 to display an image corresponding to an aerial image. The information processing device 30 also outputs audio signals to the speaker 40 and the woofer 42 to produce voice guidance and sound effects. This information processing device 30 can also be a commercially available general-purpose small personal computer or a general-purpose tablet.

The liquid crystal display 10 is housed in a housing member 12, which is rectangular in plan view, with an open top and is supported almost horizontally with the display screen facing upward. A pair of rims 14 protrude from the upper edge of the left and right side walls of the housing member 12 (see FIG. 3). A pair of rims 54 with engagement grooves 52 are also provided on the upper edge of the left and right side walls inside the housing 50. By engaging the rims 14 of the housing member 12 with the engagement grooves 52 inside the housing 50, the housing member 12 is supported so that it can slide back and forth inside the housing 50.

Further, at the rear of the housing member 12, which is slidably supported inside the housing 50, a tail member 18 extends with a rack gear 16 on its lower surface. On the other hand, a support beam 55 extending from the rear inner side of the housing 50 rotatably supports a pinion 56 that engages with the rack gear 16. A certain torque is set for the rotation of the pinion 56, so that the housing member 12 (and the liquid crystal display 10 housed therein) can be slid manually in the front-rear direction of the aerial image display device 1 and can be stopped (held) at any position.

The optical plate 20 is fitted into the lid member 22 so that the incident surface 21 faces downward and is obliquely opposed to the display screen of the liquid crystal display 10. The lid member 22 is pivotally supported on the upper front end of the housing 50, which serves as the support for the optical plate 20, around the rotation shaft 26. The movable range here is such that the angle of the lid member 22 (optical plate 20) with respect to the display screen of the liquid crystal display 10 is from 0 degrees (horizontal) to 45 degrees.

As such an optical plate 20, for example, the optical imaging element (two-surface orthogonal reflector) described in Japanese Patent Published Application No. 2011-175297 can be used. This optical imaging element is realized by arranging a large number of planar light reflecting parts orthogonal to each other at a certain pitch. Alternatively, a two-surface corner reflector structure with reflective surfaces formed on the sides of a rectangular hole as described in Japanese U.S. Pat. No. 4,900,618 may be used.

In addition, a torque hinge is used for the pivotal support part (rotation shaft 26) of the lid member 22, and a free-stop function is implemented so that the lid member 22 and the optical plate 20 can be held at any angle with respect to the housing 50. Here, a typical angle of the optical plate 20 with respect to the liquid crystal display 10 in a preferred use state is about 45 degrees as an example. As described later, this angle can be adjusted as appropriate according to the user's eye height, the installation location of the aerial image display device 1, and the usage mode.

As shown in FIG. 2, light from the display screen of the liquid crystal display 10 enters the optical plate 20, is reflected twice inside the optical plate 20, and is emitted to the opposite side. As a result, an aerial image G is displayed as a real image in the space on the opposite side of the optical plate 20. In this case, to achieve a clearer aerial image G, it is desirable that no external light is added to the light from the liquid crystal display 10.

Therefore, in the aerial image display device 1 according to the present invention, a stretchable resin light-shielding member consisting of light-shielding plates 58-1, 58-2, and 58-3 is provided to block the space between the optical plate 20 and the housing 50 (liquid crystal display 10). Each of the light-shielding plates 58-1, 58-2, and 58-3 consists of a pair of fan portions F on the left and right and a back portion B forming part of a cylindrical surface that continuously connects the pair of fan portions F.

Similarly to the lid member 22, each of the light-shielding plates 58-1, 58-2, and 58-3 is pivotally supported on the housing 50 around the rotation shaft 26. These light-shielding plates 58-1, 58-2, and 58-3 overlap each other in a slidable manner in the pivoting direction of the lid member 22, surrounding the space between the lid member 22 and the housing 50.

That is, the light-shielding plates 58-1, 58-2, and 58-3 are similar in shape, but the light-shielding plate 58-1 is only about the thickness of a plate larger than the light-shielding plate 58-2 and can be stored on top of the light-shielding plate 58-2. Similarly, the light-shielding plate 58-2 is only about the thickness of a plate larger than the light-shielding plate 58-3 and can be stored on top of the light-shielding plate 58-3. Furthermore, in the state where the light-shielding plates 58-1 and 58-2 are stacked on the light-shielding plate 58-3 as one, as shown in FIG. 5, the light-shielding plate 58-3 is sized to fit inside the housing 50.

The light-shielding plate 58-1 is integrally fixed to the back of the lid member 22, the light-shielding plate 58-2 is coupled to the light-shielding plate 58-1, and the light-shielding plate 58-3 is coupled to the light-shielding plate 58-2. Namely, an inward protrusion 58-1q is provided at the lower end of the light-shielding plate 58-1, which engages with an outward protrusion 58-2p provided at the upper end of the light-shielding plate 58-2 in the most open state as shown in FIG. 2. Similarly, in the most open state as shown in FIG. 2, an inward protrusion 58-2q provided at the lower end of the light-shielding plate 58-2 engages with an outward protrusion 58-3p provided at the upper end of the light-shielding plate 58-3. Furthermore, an inward protrusion 58-3q provided at the lower end of the light-shielding plate 58-3 engages with an outward protrusion 50p provided at the upper end of the housing 50. This ensures that the light-shielding plates 58-1, 58-2, and 58-3, which are elements of the light-shielding member, are coupled without separating from each other.

When the aerial image display device 1 is manually closed from the open state (open state) shown in FIGS. 1 to 4 by rotating the lid member 22 clockwise around the rotation shaft 26 as in FIG. 2, the aerial image display device 1 can be folded compactly. In the state where the lid member 22 is horizontal (closed state), as shown in FIG. 5, it is folded most compactly. This state is convenient for carrying and is space-saving and suitable for storage. In the open state as shown in FIGS. 1 to 4, the optical plate 20 is in the operating position as the aerial image G is formed, and in the closed state as shown in FIG. 5, the optical plate 20 is in the portable position as the aerial image G is not formed but is suitable for carrying.

In addition, since the lid member 22 is pivotally supported on the housing 50 by a torque hinge, it can be held and stopped at any angle between the 45-degree inclined state shown in FIG. 2 and the horizontal state shown in FIG. 4. FIG. 6 shows the state where the lid member 22 is stopped at 30 degrees, which is an intermediate position between the above operating position and the above portable position. In this state, the aerial image G is displayed at an inclination of 60 degrees with respect to the horizontal direction, so it can be used as if looking in from slightly above.

As described above, the aerial image display device 1 according to the present invention is equipped with an optical plate 20 that can be freely opened and closed and a stretchable light-shielding member (light-shielding plates 58-1, 58-2, 58-3). Therefore, it is possible to achieve a clear aerial image by eliminating the influence of external light, and at the same time, the aerial image display device 1 can be folded compactly and carried freely. Furthermore, at the same time, the aerial image display device 1 according to the present invention also makes it possible to enjoy the additional advantage that the optical plate 20 can be used at an intermediate angle between the open and closed states without any special additional components.

Furthermore, on the front side of the housing 50, an infrared LED 72 and a pair of infrared cameras 74 are provided. These infrared LED 72 and infrared cameras 74 constitute an operation detection unit that detects operations performed by the user on the aerial image G. The detection range of the operation detection unit is defined by the emission angle of the infrared LED 72 and the angle of view of the infrared cameras 74.

If a non-contact interface screen is displayed as the aerial image G, it is possible to operate the non-contact interface screen by gestures such as touching with a finger. The operation is detected by the operation detection unit consisting of the infrared LED 72 and infrared cameras 74, and the corresponding operation signal is sent to the information processing device 30 for predetermined processing. The operation interface may include controls such as buttons, checkboxes, and drop-down menus. Accordingly, it is possible to realize a completely non-contact interface with usability similar to conventional touch panels.

According to the portable aerial image display device of the present invention, it is possible to achieve a clear aerial image by eliminating the influence of external light, and at the same time, it can be folded compactly and carried freely.

The portable aerial image display device according to the present invention has been described above with reference to the embodiments, but the present invention is not limited thereto, and modifications may be made within the scope not departing from the spirit of the invention, and, if possible, the technologies described in each embodiment may be combined or combined with known technologies.

Here, as a stretchable light-shielding member, light-shielding plates 58-1, 58-2, and 58-3, which are pivotally supported on the housing 50 around the rotation shaft 26, are provided between the lid member 22 and the housing 50. However, the present invention is not limited to this. For example, a bellows made of paper, plastic, cloth, or other materials with a repeated mountain and valley fold (accordion shape) may be provided between the lid member 22 and the housing 50 as a stretchable light-shielding member.

Also, in the above embodiment, a torque hinge is used to implement the free-stop function for holding the lid member 22 and the optical plate 20 at any angle with respect to the housing 50. However, the present invention is not limited to this. For example, as shown in FIG. 7, a right and left pair of telescopic rods 80 may be provided between the housing 50 and the lid member 22 to implement the free-stop function. Such a telescopic rod 80 may be a gas spring structure that can be locked at any position either rigidly or elastically.

Furthermore, in the above embodiment, the information processing device 30 is implemented in the aerial image display device 1, but the present invention is not limited to this. For example, the information processing device 30 may be omitted, and an external input terminal for inputting video signals to the liquid crystal display 10 or an external audio input terminal for inputting audio signals to the speaker or woofer may be provided in the aerial image display device 1 so that necessary video and audio signals can be supplied from an external computer or the like.

Furthermore, in the above embodiment, the optical plate 20 is pivotally movable and its angle can be adjusted, but the liquid crystal display 10 is fixed at a predetermined position. Therefore, if the angle of the optical plate 20 is adjusted, the angle between the optical plate 20 and the aerial image G inevitably changes. To adjust the angle of the optical plate 20 without changing the angle between the optical plate 20 and the aerial image G, the angle between the liquid crystal display 10 and the optical plate 20 should be fixed. Namely, the liquid crystal display 10 may also be pivotally supported by a hinge together with the optical plate 20 in order that, if the angle of the optical plate 20 is reduced, the liquid crystal display 10 moves downward by the same angle. In this way, it is possible to adjust the angle of the optical plate 20 without changing the angle between the optical plate 20 and the aerial image G.

Furthermore, in the above embodiment, the liquid crystal display 10 (housing member 12) can be manually slid in the front-rear direction of the aerial image display device 1, but it may be made manually movable in the vertical direction. Alternatively, the liquid crystal display device may be made adjustable in both the front-rear and vertical directions. When the liquid crystal display 10 is moved in the front-rear direction, the aerial image G moves in the vertical direction. When the liquid crystal display 10 is moved in the vertical direction, the aerial image G moves in the front-rear direction. In this way, the user can adjust the aerial image G to the most convenient position.

Furthermore, in the above embodiment, the operation detection unit consists of the infrared LED 72 and an infrared cameras 74, but the present invention is not limited to this, and, for example, the operation detection unit may be composed of multiple visible light cameras.

Furthermore, in the above embodiment, the liquid crystal display 10 (housing member 12) can be manually slid in the front-rear direction of the aerial image display device 1, but a lifting mechanism may be provided so that the liquid crystal display 10 can be moved in the vertical direction. Alternatively, the position of the liquid crystal display 10 may be made movable in both the front-rear and vertical directions of the aerial image display device 1. When the liquid crystal display 10 is moved in the front-rear direction, the aerial image G moves in the vertical direction. When the liquid crystal display 10 is moved in the vertical direction, the aerial image G moves in the front-rear direction. In this way, the user can adjust the aerial image G to the most convenient position.

Furthermore, in the above embodiment, a liquid crystal display is used, but the present invention is not limited to this, and an organic EL display or electronic paper with a backlight may also be used.

### EXPLANATION OF SYMBOLS

1 aerial image display device
10 liquid crystal display
12 housing member
14 rim
16 rack gear
18 tail member
20 optical plate
21 incident surface
26 rotation shaft
30 information processing device
40 speaker
42 woofer
50 housing
52 engagement groove
54 rim
55 support beam
56 pinion
58-1, 58-2, 58-3 light-shielding plates
58-2p, 58-3p, 50p outward protrusions
58-1q, 58-2q, 58-3q inward protrusions
72 infrared LED
74 infrared camera
80 telescopic rod

1-5. (canceled)

6. A portable aerial image display device comprising:
a housing;
an information processing device provided inside the housing;
a display device provided in the housing;
an optical plate pivotally provided at the top of the housing and capable of pivoting from a portable position substantially parallel to the display device to an operating position held at a predetermined angle with respect to the display device; and
a light-shielding member surrounding the space between the optical plate and the housing and expanding and contracting in accordance with changes in the gap between the housing and the optical plate as the space expands and contracts due to the rotation of the optical plate relative to the housing;
wherein the light-shielding member comprises a plurality of light-shielding plates that overlap each other in a slidable manner in the pivoting direction of the optical plate and substantially surround the space between the optical plate and the housing without gaps; and
wherein each of the light-shielding plates comprises a pair of fan portions on the left and right and a back portion forming part of a cylindrical surface that continuously connects the pair of fan portions.

7. The portable aerial image display device according to claim 6, wherein the support is provided with a mechanism for adjusting the position of the display device so that the relative position between the optical plate and the display device is variable.

8. The portable aerial image display device according to claim 6, wherein the housing can also hold the optical plate at an intermediate position between the operating position and the portable position, and at this intermediate position, the image displayed on the display device is formed as an aerial image on the opposite side of the optical plate.

9. The portable aerial image display device according to claim 7, wherein the pivotal support structure between the housing and the optical plate is provided with a free-stop function that holds the optical plate at any angle relative to the housing.

10. The portable aerial image display device according to claim 9, wherein the free-stop function is implemented by a torque hinge.
